(19) United States
(12) Patent Application Publication
(10) Pub. No.: US 2014/0317733 A1
(43) Pub. Date: Oct. 23, 2014

(54) METHOD AND CLIENT FOR ENSURING USER NETWORK SECURITY

(71) Applicants: Ningyi Chen, Beijing (CN); Wenbin Zheng, Beijing (CN); Peng Xiao, Beijing (CN); Yipeng Zhu, Beijing (CN)

(72) Inventors: Ningyi Chen, Beijing (CN); Wenbin Zheng, Beijing (CN); Peng Xiao, Beijing (CN); Yipeng Zhu, Beijing (CN)

(73) Assignee: BEIJING QIHOO TECHNOLOGY COMPANY LIMITED, BEIJING, CN (CN)

(21) Appl. No.: 14/112,059

(22) PCT Filed: Apr. 17, 2012
(86) PCT No.: PCT/CN2012/074191

§ 371 Date: Jul. 9, 2014

(30) Foreign Application Priority Data
Apr. 18, 2011 (CN) 201110097169X

(51) Int. Cl. H04L 29/06; G06Q 20/38

(52) U.S. Cl. CPC H04L 63/1441; G06Q 20/382
USPC 726/22

(57) ABSTRACT

A method and client for ensuring user network security, the method comprising: detecting whether a user opens a login operation mode or payment operation mode via a client; and when detecting that the user opens the login operation mode or payment operation mode, performing security monitoring for the login procedure or payment procedure of the user according to a preset security strategy. By applying the embodiment of the present invention, when a client user is in a login procedure or online payment procedure, security protection can be implemented for the login procedure or payment procedure via multiple security strategies specially used for ensuring the login procedure or payment procedure, and network security is ensured for the user during the login procedure or payment procedure via risky process interception, executable file prompt and browser invoke monitoring.

### FIELD OF THE INVENTION

The present application relates to the field of computer network technologies, and particularly to a method and client for ensuring user network security.

### BACKGROUND OF THE INVENTION

As the expansion of network application, a network user may pay various fees online, wherein the commonest application is that when the user logs in an online shopping mall, he/she performs online transfer payment through a pre-opened network bank. During payment through the network bank, the user needs to enter a bank card account number and a preset password, so it is of vital importance to safeguard security of network payment. In the prior arts, a malicious third party usually steals the user's network bank account number and password via a Trojan horse, for example, when the user clicks a payment button on a web page, the payment web page that the user might enter is a malicious web page which is preset by the malicious third party and similar to a normal payment web page, and once the user enters the user's name and password on the malicious web page, the user's information might be stolen. In light of this, in current network payment, the user's network bank is likely to be stolen so that network security is not high and is likely to result in loss of the user.

### SUMMARY OF THE INVENTION

In order to solve the above technical problems, embodiments of the present application provide a method and client for ensuring user network security, to address the problem that the user's information is easily stolen during current network payment so that the network security is not high.

Embodiments of the present application disclose the following technical solutions:

A method for ensuring user network security, comprising:

detecting whether the user opens a login operation mode or payment operation mode via a client; and

performing security monitoring for the user's login procedure or payment procedure according to a preset security strategy after detecting that the user has opened the login operation mode or payment operation mode, so as to, when an insecure event is monitored, prompt the user or stop execution of the insecure event.

Wherein,

detecting whether the user opens a login operation mode or payment operation mode via a client comprises: detecting whether the user opens the login operation mode or payment operation mode via a client browser.

Wherein, performing security monitoring for the user's login procedure or payment procedure according to a preset security strategy comprises at least one of the following manners:

monitoring dangerous processes in the login procedure or payment procedure according to a preset process list;

monitoring executable files transferred in the login procedure or payment procedure;

monitoring a browser invoking behavior in the login procedure or payment procedure;

monitoring invocation of keyboard-input content in the login procedure or payment procedure;

monitoring data objects transferred by the client in the login procedure or payment procedure; and

monitoring web pages opened in the login procedure or payment procedure.

Wherein, monitoring dangerous processes in the login procedure or payment procedure according to a preset process list comprises:

acquiring a current process opened in the login procedure or payment procedure, and determining the current process as a dangerous process and intercepting it when the current process is not found from the preset white list, wherein the preset white list is used to store secure processes which are already confirmed as not threatening the system; or

acquiring the current process opened in the login procedure or payment procedure, and determining the current process as a dangerous process and intercepting it when the current process is found from the preset black list, wherein the preset black list is used to store dangerous processes which are already confirmed as threatening the system.

Wherein, monitoring executable files transferred in the login procedure or payment procedure comprises:

determining whether an executable file is a suspicious file by looking up from the preset executable file list when detecting that the client gets prepared to receive an executable file or is in a procedure of receiving an executable file or has already received an executable file.

Wherein, determining whether an executable file is a suspicious file by looking up from the preset executable file list comprises:

determining the executable file as a suspicious file when the executable file is not found from the preset white list, wherein the preset white list is used to store all secure executable files; or

determining the executable file as a suspicious file when the executable file is found from the preset black list, wherein the preset black list is used to store all dangerous executable files.

Wherein, monitoring executable files transferred in the login procedure or payment procedure comprises:

when the client is detected to have received an executable file, extracting behavior characteristics of the executable file, judging whether the behavior characteristics extracted from the executable files are pre-recorded secure behavior characteristics, and determining the executable file as the suspicious file if not.

Wherein monitoring a browser invoking behavior in the login procedure or payment procedure comprises:

monitoring a function relevant to communication between processes via underlying drive;

intercepting a corresponding invoking event when relevant function invocation triggered by an operation to the browser process by a remote procedure invoking interface is monitored;

parsing the invoking event, and filtering out a process of initiating the invoking event; and

determining whether the process of initiating the invoking event is an illegal process by looking up from a preset process list.

A client, comprising:

a detecting unit configured to detect whether the user opens a login operation mode or payment operation mode via the client; and

a monitoring unit configured to perform security monitoring for the user's login procedure or payment procedure according to a preset security strategy after the user's login operation mode or payment operation mode is detected, so as to, when an insecure event is monitored, prompt the user or stop execution of the insecure event.

Wherein, the detecting unit is specifically configured to detect whether the user opens the login operation mode or payment operation mode via a client browser.

Wherein, the monitoring unit comprises at least one of the following units:

a dangerous process monitoring unit configured to monitor dangerous processes in the login procedure or payment procedure according to a preset process list;

an executable file monitoring unit configured to monitor the executable file transferred in the login procedure or payment procedure;

a browser invocation monitoring unit configured to monitor a browser invoking behavior in the login procedure or payment procedure;

a keyed content invocation monitoring unit configured to monitor the invocation of keyboard-input content in the login procedure or payment procedure;

a data object monitoring unit configured to monitor data objects transferred by the client in the login procedure or payment procedure; and

a webpage monitoring unit configured to monitor web pages opened in the login procedure or payment procedure.

Wherein, the dangerous process monitoring unit comprises at least one of the following units:

a white list intercepting unit configured to acquire the current process opened in the login procedure or payment procedure, and determine the current process as a dangerous process and intercept it when the current process is not found from the preset white list, wherein the preset white list is used to store secure processes which are already confirmed as not threatening the system; and

a black list intercepting unit configured to acquire the current process opened in the login procedure or payment procedure, and determine the current process as a dangerous process and intercept it when the current process is found from the preset black list, wherein the preset black list is used to store dangerous processes which are already confirmed as threatening the system.

Wherein, the executable file monitoring unit comprises:

a first executable file monitoring unit configured to determine whether the executable file is a suspicious file by looking up from the preset executable file list when detecting that the client gets prepared to receive an executable file or is in a procedure of receiving an executable file or has already received an executable file.

Wherein, the first executable file monitoring unit comprises:

a white list monitoring unit configured to determine the executable file as a suspicious file when the executable file is not found from the preset white list, wherein the preset white list is used to store all secure executable files; or

a black list monitoring unit configured to determine the executable file as a suspicious file when the executable file is found from the preset black list, wherein the preset black list is used to store all dangerous executable files.

Wherein, the executable file monitoring unit comprises:

a second executable file monitoring unit configured to, when the client is detected to have received an executable file, extract behavior characteristics of the executable file, judge whether the behavior characteristics extracted from the executable files are pre-recorded secure behavior characteristics, and determine the executable file as the suspicious file if not.

Wherein, the browser invocation monitoring unit comprises:

a function monitoring unit configured to monitor a function relevant to communication between processes via underlying drive;

an invoking event intercepting unit configured to intercept a corresponding invoking event when relevant function invocation triggered by an operation to the browser process by a remote procedure invoking interface is monitored;

an invoking event parsing unit configured to parse the invoking event and filter out a process of initiating the invoking event; and

an illegal process determining unit configured to determine whether the process of initiating the invoking event is an illegal process by looking up from a preset process list.

As known from the above embodiments, in embodiments of the present application, after detecting that the user opened the login operation mode or payment operation mode, security monitoring is performed for the user's login procedure or payment procedure according to preset security strategy. By applying the embodiment of the present invention, when a client user is in the login procedure or online payment procedure, security protection can be performed for the login procedure or payment procedure via multiple security strategies specially used for ensuring the login procedure or payment procedure, and network security is ensured for the user during the login procedure or payment procedure via risky process interception, executable file prompt and browser invocation monitoring.

### BRIEF DESCRIPTION OF THE DRAWINGS

The drawings used in describing embodiments or prior art will be briefly introduced to more clearly illustrate technical solutions on embodiments of the present application or in the prior art, and obviously, those having ordinary skill in the art may obtain other drawings according to these drawings without making any inventive efforts.

FIG. 1 is a flow chart of a first embodiment of a method of ensuring user network security of the present application;

FIG. 2 is a flow chart of a second embodiment of a method of ensuring user network security of the present application;

FIG. 3 is a flow chart of a third embodiment of a method of ensuring user network security of the present application;

FIG. 4 is a flow chart of a fourth embodiment of a method of ensuring user network security of the present application; and

FIG. 5 is a block diagram of an embodiment of a client of the present application.

### DETAILED DESCRIPTION OF THE INVENTION

The following embodiments of the present invention provide a method and a client for ensuring user network security.

Technical solutions in the embodiments of the present invention will be described in more detail with reference to the drawings to help those skilled in the art to better understand the technical solution in the embodiments of the present invention, and make the above objects, features and advantages of embodiments of the present invention more apparent.

Referring to FIG. 1, it is a flow chart of a first embodiment of a method of ensuring user network security of the present application.

Step 101: detecting whether the user opens a login operation mode or payment operation mode via a client.

The embodiment of the present application may be particularly applied to the procedure of network payment by a user via a client, namely, detecting whether the user opens a payment page via a client, to ensure that the user's information will not leak and improve security of network payment. Specifically, detecting whether the user opens the login operation mode or payment operation mode via a client browser

Step 102: performing security monitoring for the user's login procedure or payment procedure according to a preset security strategy after detecting that the user has opened the login operation mode or payment operation mode.

Wherein, the security strategy is a security strategy which is preset for the login operation mode or payment operation mode.

The client may monitor dangerous processes in the login procedure or payment procedure according to a preset process list; or monitor executable files transferred in the login procedure or payment procedure according to a preset secure executable file list; or monitor a browser invoking behavior in the login procedure or payment procedure; or monitor the invocation of keyboard-input content in the login procedure or payment procedure; or monitor data objects transferred by the client in the login procedure or payment procedure, for example, when it is monitored that the client transfers login or payment-related data to objects irrelevant to the login procedure or payment procedure, the transferred data objects shall be intercepted; or monitor web pages opened in the login procedure or payment procedure, for example, in the login procedure or payment procedure the payment webpage that might be opened by the user is a webpage that is counterfeited by the malicious third party and similar to a true payment webpage, so there is a need to monitor the opened webpage.

It would be noted that, the above-listed six security strategy executing modes may be parallelly executed in the whole monitoring procedure, or at least one of them is selected and executed according to needs, by which embodiments of the present application is not limited.

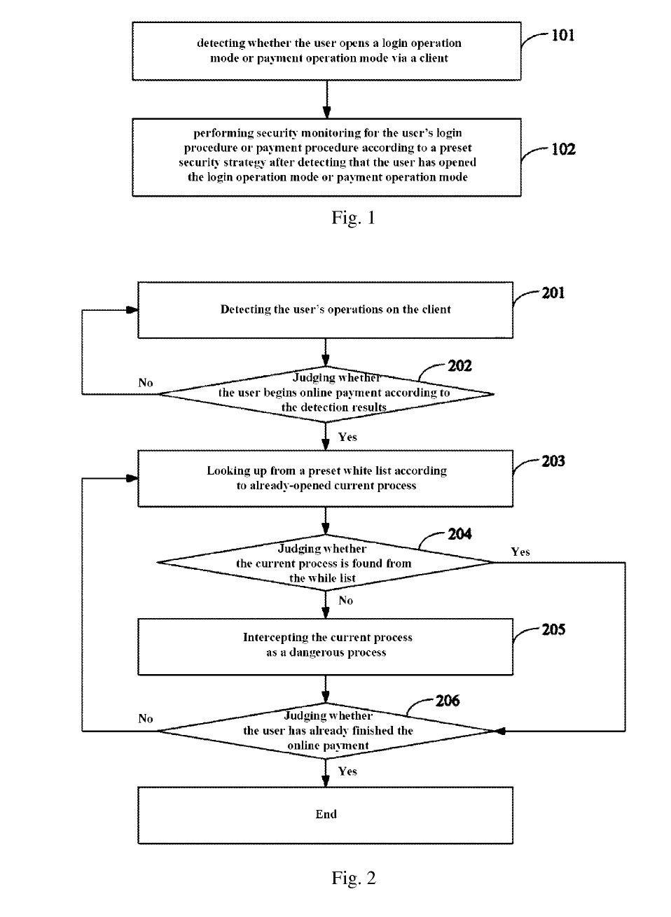

Referring to FIG. 2, which is a flow chart of a second embodiment of a method of ensuring user network security of the present application, this embodiment takes online payment as an example to illustrate a procedure of monitoring dangerous process.

Step 201: detecting the user's operations on the client.

Step 202: judging whether the user begins online payment according to the detection results, and executing step 203 if yes; returning to step 201 if no.

A payment website list may be pre-stored in the user's client, and after detecting that the user has opened the browser, a URL (Uniform/Universal Resource Locator, webpage address) of the page visited by the browser is acquired, the acquired URL is compared with payment website URLs in the payment website list; if a consistent URL is found, it may be confirmed that the user enters the payment page and begins the online payment.

Step 203: looking up from a preset white list according to already-opened current process.

What are stored in the white list are already-confirmed secure processes not threatening the system, so these processes may not be intercepted.

The white list is usually stored in the local, so an operation of looking up from the white list is correspondingly executed locally. Further, it is also possible to connect a cloud server during operation of the current process in combination with cloud killing, and look up whether the current process is a secure process according to a plurality of white lists already stored in the network.

During the whole online payment, it is possible to open a plurality of processes. After each process is opened, the operation of looking up from the white list is executed for this process as the current process.

Step 204: judging whether the current process is found from the while list, and executing step 205 if not found; executing step 206 if found.

Step 205: intercepting the current process as a dangerous process.

For the processes not found from the white list, they may be directly intercepted as dangerous processes, or they may be prompted to the user and the user may decide whether to permit or prevent execution of the process. For the processes not found from the white list, functions for limiting execution of these processes may be provided to the user, which include, but not limited to, freezing process, isolating process and terminating process.

The present embodiment takes white list lookup as an example to illustrate the interception procedure of the dangerous processes, and in actual applications, a black list may be preset. When the current process is found from the black list, the current process will be intercepted as a dangerous process; for processes not found from the while list or the black list, they may be prompted to the user and the user decides whether to stop operation of these processes to prevent dangerous processes that might exist in the unknown processes.

Step 206: judging whether the user has already finished the online payment, and ending up the flow route if yes; returning to step 203 if no.

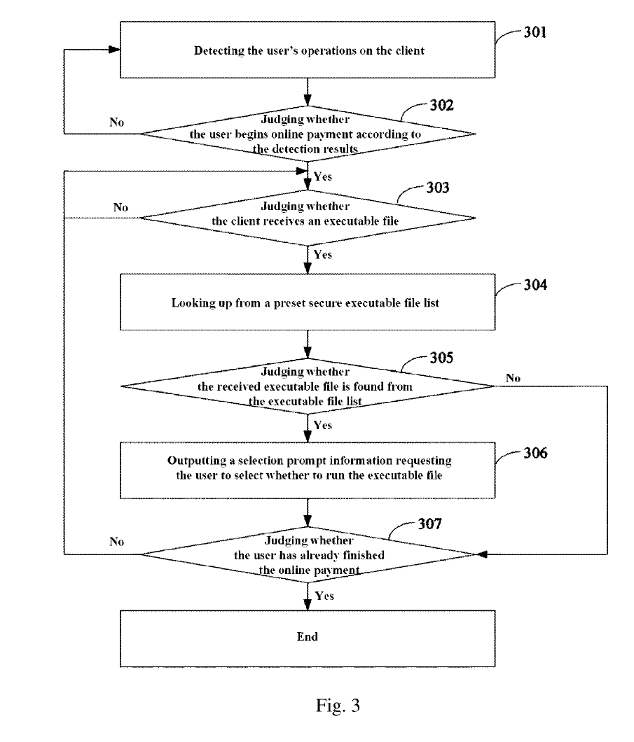

Referring to FIG. 3, which is a flow chart of a third embodiment of a method of ensuring user network security of the present application, this embodiment takes online payment as an example to illustrate a procedure of monitoring executable files received during security payment according to a preset secure executable file list:

Step 301: detecting the user's operations on the client.

Step 302: judging whether the user begins online payment according to the detection results, and executing step 303 if yes; returning to step 301 if no.

A payment website list may be pre-stored in the user's client, and after detecting that the user has opened the browser, a URL of the page visited by the browser is acquired, the acquired URL is compared with payment website URLs in the payment website list; if a consistent URL is found, it may be confirmed that the user enters the payment page and begins the online payment.

Step 303: judging whether the client receives an executable file, and executing step 304 if yes; returning to step 303 if no.

During the user's online payment, it is possible to receive executable files (e.g., a file with an extention .exe) transferred by the third party to the user. Some of these executable files are files to be used during payment, and some are dangerous files sent by the malicious third party to the user. The above-mentioned files might be transferred to a terminal equipment of the user via a real-time communication tool, might be downloaded to his terminal equipment by the user who is induced in a downloading or sharing manner, might be propagated to the terminal equipment of the user in an illegal manner such as hanging a Trojan horse or virus spreading, or might be transferred to the terminal equipment of the user when copying files in a mobile storage device.

When detecting the executable files, they may be monitored by the user's real-time communication tool, browser or the like, or may be detected in real time when the files are downloaded to the local. In addition, the executable files may also be detected by the system upon and after starting or running the files.

Step 304: looking up from a preset secure executable file list.

file size, file time, file MD5 information, file signature and the like may be recorded in the secure executable file list.

The secure executable file list may employ a white list manner in which the white list stores all secure executable files; or employs a black list manner in which the black list stores all dangerous executable files; or employs a behavior characteristic manner in which all secure behavior characteristics are recorded: after executable files are received, behavior characteristics of executable files are extracted, judgment is performed as to whether the behavior characteristics extracted from the executable files satisfy the recorded secure behavior characteristics, and files satisfying the secure behavior characteristics may be confirmed as secure executable files.

Step 305: judging whether the received executable file is found from the executable file list, and executing step 306 if yes; executing step 307 if no.

Step 306: outputting a selection prompt information which requests the user to select whether to run the executable file.

Step 307: judging whether the user has already finished the online payment, and ending up the flow route if yes; returning to step 303 if no.

Besides monitoring the executable files received during secure payment illustrated in the above embodiments, it is also possible to monitor an executable file which the client gets prepared to receive or is receiving. Specifically, when detecting that the client gets prepared to receiving an executable file, it will be looked up from the preset secure executable file list. If the executable file is not found from the executable file list, it is determined as a suspicious file, and a selection prompt information is outputted to request the user to select whether to run the executable file; when detecting that the client is in a procedure of receiving an executable file, it will be looked up from the preset secure executable file list. If the executable file is not found from the executable file list, it is determined as a suspicious file, and a selection prompt information is outputted to request the user to select whether to continue to receive the executable file.

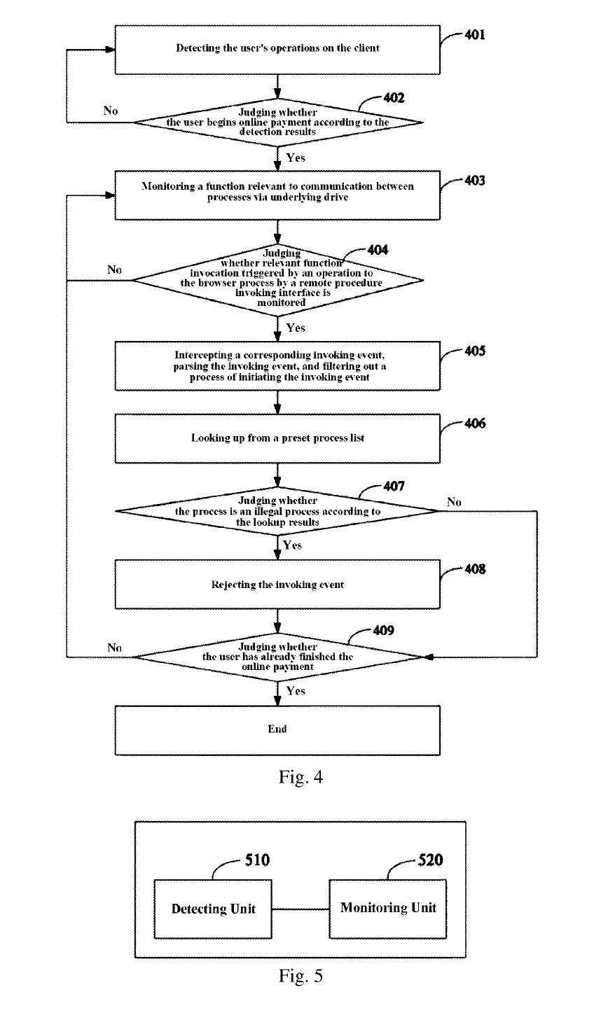

Referring to FIG. 4, which is a flow chart of a fourth embodiment of a method of ensuring user network security of the present application, this embodiment takes online payment as an example to illustrate a procedure of monitoring browser invocation during secure payment.

Step 401: detecting the user's operations on the client.

Step 402: judging whether the user begins online payment according to the detection results, and executing step 403 if yes; returning to step 401 if no.

A payment website list may be pre-stored in the user's client, and after detecting the user has opened the browser, a URL of the page visited by the browser is acquired, the acquired URL is compared with payment website URLs in the payment website list; if a consistent URL is found, it may be confirmed that the user enters the payment page and begins the online payment.

Step 403: monitoring a function relevant to communication between processes via underlying drive.

For the online payment procedure, a communication function between processes monitored by the underlying drive may include an API (Application Programming Interface) function exemplified as follows:

NtAlpcSendWaitReceivePort

NtRequestWaitReplyPort

NtRequestPort

Step 404: judging whether relevant function invocation triggered by an operation to the browser process by a remote procedure invoking interface is monitored, and executing step 405 if yes; returning to step 403 if no.

When a program attempts to invoke relevant function of communication between processes, operation for an interface of the browser process will be performed by the remote procedure invoking interface (e.g., COM interface). When the operation attempts to control content of a website or page of the browser process, a corresponding function invoking event will be monitored, and at this time interception of function invocation will be triggered.

Step 405: intercepting a corresponding invoking event, parsing the invoking event, and filtering out a process of initiating the invoking event.

The intercepted invoking event is an event invoking the function. Usually, the invoked function is a function invoked in a RPC (Remote Procedure Call) procedure, whereupon the invoked function is parsed, for example, if the parsed invoked function is NtRequestWaitReplyPort, the relevant function as parsed out may include RequestMessage, PortHandle and the like.

When the function invocation triggered by the operation to the browser process by the remote procedure invoking interface is filtered, for example, process A attempts to operate the browser process B to jump to a malicious website C to hijack an network shipping procedure of online payment, the process A will connect the remote procedure invoking interface of the browser process B and generate a PortHandle, then information such as an invoking serial number and a jumping website for invoking is packaged in the parameter RequestMessage of the function NtRequestWaitReplyPort (the RequestMessage is a buffer address), and finally the function NtRequestWaitReplyPortAPI is invoked, to send a jumping request to the remote procedure invoking port of the browser process B to achieve the jump operating procedure. In the present embodiment, parsing and recovering the information such as the invoking serial number and jumping website of the invoked function from the buffer of the parameter RequestMessage by intercepting and monitoring the function NtRequestWaitReplyPort, identifying the information as an operating browser invoking event, and acquiring the process A for triggering the browser invoking event.

Step 406: looking up from a preset process list.

After the process A for triggering the browser invoking event is acquired, a process ID of the process, an execution path, file information of the corresponding file and the like may be acquired. The corresponding file is acquired according to the execution path, and an abstract of the file is calculated to acquire hash information representative of uniqueness of the file.

The process list may employ a white list manner or a black list manner. When the white list manner is employed, the white list includes hash information of files corresponding to all secure processes. The hash information of the acquired process is compared with the hash information in the white list, and if there exits consistent hash information, this indicates that the acquired process is a secure process which need not be intercepted; if there still exits the black list, the process matching and conforming to the hash information in the black list is intercepted and an alarm is emitted; those processes corresponding to the hash information neither in the white list nor in the black list may be intercepted and a prompt is sent to the user.

Step 407: judging whether the process is an illegal process according to lookup results, and executing step 408 if yes; executing step 409 if no.

Step 408: rejecting the invoking event.

Step 409: judging whether the user has already finished the online payment, and ending up the flow if yes; returning to step 403 if no.

As can be seen from the above embodiments, when the user on the client performs a login operation, particularly during online payment, security protection may be performed for the payment procedure by means of many security strategies, and network security during the user's login procedure is ensured by intercepting dangerous processes, prompting executable files and monitoring the browser invocation.

The present application further provides an embodiment of the client, corresponding to the embodiments illustrating the method for ensuring the user network security.

Referring to FIG. 5, it is a block diagram of an embodiment of a client of the present application.

The client comprises: a detecting unit 510 and a monitoring unit 520.

Wherein, the detecting unit 510 is configured to detect whether the user opens a login operation mode or payment operation mode via a client;

the monitoring unit 520 is configured to perform security monitoring for the user's login procedure or payment procedure according to a preset security strategy after the user's login operation mode or payment operation mode is detected, to prompt the user or stop execution of an insecure event when the insecure event is monitored.

Wherein, the security strategy is a security strategy which is preset and dedicated to safeguard the login procedure or payment procedure; the detecting unit 510 is specifically used to detect whether the user opens the login operation mode or payment operation mode via a client browser.

Wherein, the monitoring unit 520 may comprise at least one of the following units (not shown in FIG. 5):

a dangerous process monitoring unit configured to monitor dangerous processes in the login procedure or payment procedure according to a preset process list;

an executable file monitoring unit configured to monitor executable files transferred in the login procedure or payment procedure;

a browser invocation monitoring unit configured to monitor a browser invoking act in the login procedure or payment procedure;

a keyed content invocation monitoring unit configured to monitor the invocation of keyboard-input content in the login procedure or payment procedure;

a data object monitoring unit configured to monitor data objects transferred by the client in the login procedure or payment procedure; and

a webpage monitoring unit configured to monitor web pages opened in the login procedure or payment procedure.

Specifically, the dangerous process monitoring unit may comprise at least one of the following units:

a white list intercepting unit configured to preset a white list, acquire the current process in the login procedure or payment procedure, and intercept the current process as a dangerous process when the current process is not found from the white list; and

a black list intercepting unit configured to preset a black list, acquire the current process in the login procedure or payment procedure, and intercept the current process as a dangerous process when the current process is found from the black list.

Specifically, the executable file monitoring unit may comprise at least one of the following units:

a first executable file monitoring unit configured to look up the executable file from the preset executable file list when detecting that the client gets prepared to receive the executable file, determine the executable file as a suspicious file if the executable file is not found from the executable file list, and output a selection prompt information to request the user to select whether to receive the executable file; or configured to look up the executable file from the preset executable file list when the client is detected in the procedure of receiving the executable file, determine the executable file as a suspicious file if the executable file is not found from the executable file list, and output a selection prompt information to request the user to select whether to continue to receive the executable file; or configured to look up the executable file from the preset executable file list when the client is detected to have already received an executable file, determine the executable file as a suspicious file if the executable file is not found from the executable file list, and output a selection prompt information to request the user to select whether to run the executable file.

Wherein, the first executable file monitoring unit may comprise:

a white list monitoring unit configured to determine the executable file as a suspicious file if the executable file is not found from the preset white list, wherein the preset white list is configured to store all secure executable files; or

a black list monitoring unit configured to determine the executable file as a suspicious file if the executable file is found from the preset black list, wherein the preset black list is configured to store all dangerous executable files.

In another implementation, the executable file monitoring unit may comprise:

a second executable file monitoring unit configured to, when the client is detected to have received an executable file, extract behavior characteristics of the executable file, judge whether the behavior characteristics extracted from the executable files are pre-recorded secure behavior characteristics, and determine the executable file as the suspicious file if not.

Specifically, the browser invocation monitoring unit may comprise:

a function monitoring unit configured to monitor a function relevant to communication between processes via underlying drive;

an invoking event intercepting unit configured to intercept the corresponding invoking event when relevant function invocation triggered by an operation for the browser process by a remote procedure invoking interface is monitored;

an invoking event parsing unit configured to parse the invoking event, and filter out a process of initiating the invoking event; and

an illegal process determining unit configured to determine the process of initiating the invoking event is an illegal process by looking up from a preset process list, wherein the process list comprises comprise the white list or black list;

When needing to stop execution of the insecure event, an invoking event rejecting unit may be included and configured to reject the invoking event when the process is determined as the illegal process.

As known from the depictions of the above embodiments, in embodiments of the present application, after detecting that the user has opened the login operation mode or payment operation mode, security monitoring is performed for the user's login procedure or payment procedure according to preset security strategies. By applying the embodiment of the present invention, when a client is in the login procedure or online payment procedure, security protection can be implemented for the login procedure or payment procedure via multiple security strategies specially used for ensuring the login procedure or payment procedure, and network security is ensured for the user during the login procedure or payment procedure via risky process interception, executable file prompt and browser invocation monitoring.

Those skilled in the art would clearly understand that the technology illustrated in the embodiments of the present invention may be implemented by means of software plus necessary universal hardware platform. Based on such understanding, the essence of the technical solutions in the embodiments of the present invention, or portions contributive over the prior art may be embodied in the form of software products. Computer software products may be stored in storage media such as ROM/RAM, magnetic disk, or CD, and include a plurality of instructions to enable a computer device (which may be a PC, server, network device or the like) to execute the method described in respective embodiments or some portions of the embodiments.

Embodiments in the description all are described in a progressive manner, and reference may be made between embodiments for identical or similar portions between embodiments. Each of the embodiments focuses on content different from the remaining embodiments. Particularly, embodiments of the system are described simpler as being substantially similar to the method embodiments, so reference may be made to the partial depictions of the method embodiments for the relevant portions.

The aforesaid embodiments of the present invention do not intend to limit the protection scope of the present invention. Any amendments, equivalent substitutions and improvements within the spirit and principles of the present invention all should be included in the protection scope of the present invention.

What is claimed is:

1. A method for ensuring user network security, characterized by comprising:
detecting whether the user opens a login operation mode or payment operation mode via a client;
performing security monitoring for the user's login procedure or payment procedure according to a preset security strategy after detecting that the user has opened the login operation mode or payment operation mode, so as to, when an insecure event is monitored, prompt the user or stop execution of the insecure event.

2. The method according to claim 1, characterized in that,
detecting whether the user opens a login operation mode or payment operation mode via a client comprises: detecting whether the user opens the login operation mode or payment operation mode via a client browser.

3. The method according to claim 1, characterized in that, performing security monitoring for the user's login procedure or payment procedure according to a preset security strategy comprises at least one of the following manners:
monitoring dangerous processes in the login procedure or payment procedure according to a preset process list;
monitoring executable files transferred in the login procedure or payment procedure;
monitoring a browser invoking behavior in the login procedure or payment procedure;
monitoring invocation of keyboard-input content in the login procedure or payment procedure;
monitoring data objects transferred by the client in the login procedure or payment procedure; and
monitoring web pages opened in the login procedure or payment procedure.

4. The method according to claim 3, characterized in that, monitoring dangerous processes in the login procedure or payment procedure according to a preset process list comprises:
acquiring a current process opened in the login procedure or payment procedure, and determining the current process as a dangerous process and intercepting it when the current process is not found from the preset white list, wherein the preset white list is used to store secure processes which are already confirmed as not threatening the system; or
acquiring the current process opened in the login procedure or payment procedure, and determining the current process as a dangerous process and intercepting it when the current process is found from the preset black list, wherein the preset black list is used to store dangerous processes which are already confirmed as threatening the system.

5. The method according to claim 3, characterized in that, monitoring executable files transferred in the login procedure or payment procedure comprises:
determining whether an executable file is a suspicious file by looking up from the preset executable file list when detecting that the client gets prepared to receive an executable file or is in a procedure of receiving an executable file or has already received an executable file.

6. The method according to claim 5, characterized in that, determining whether an executable file is a suspicious file by looking up from the preset executable file list comprises:
determining the executable file as a suspicious file when the executable file is not found from the preset white list, wherein the preset white list is used to store all secure executable files; or
determining the executable file as a suspicious file when the executable file is found from the preset black list, wherein the preset black list is used to store all dangerous executable files.

7. The method according to claim 3, characterized in that, monitoring executable files transferred in the login procedure or payment procedure comprises:
when the client is detected to have received an executable file, extracting behavior characteristics of the executable file, judging whether the behavior characteristics extracted from the executable files are pre-recorded secure behavior characteristics, and determining the executable file as the suspicious file if not.

8. The method according to claim 3, characterized in that, monitoring a browser invoking behavior in the login procedure or payment procedure comprises:
monitoring a function relevant to communication between processes via underlying drive;
intercepting a corresponding invoking event when relevant function invocation triggered by an operation to the browser process by a remote procedure invoking interface is monitored;
parsing the invoking event, and filtering out a process of initiating the invoking event; and
determining the process of initiating the invoking event is an illegal process by looking up from a preset process list.

9. A client, characterized by comprising:
a detecting unit configured to detect whether the user opens a login operation mode or payment operation mode via the client; and
a monitoring unit configured to perform security monitoring for the user's login procedure or payment procedure according to a preset security strategy after the user's login operation mode or payment operation mode is detected, so as to, when an insecure event is monitored, prompt the user or stop execution of the insecure event.

10. The client according to claim 9, characterized in that,
the detecting unit is specifically configured to detect whether the user opens the login operation mode or payment operation mode via a client browser.

11. The client according to claim 9, characterized in that, the monitoring unit comprises at least one of the following units:
a dangerous process monitoring unit configured to monitor dangerous processes in the login procedure or payment procedure according to a preset process list;
an executable file monitoring unit configured to monitor the executable file transferred in the login procedure or payment procedure;
a browser invocation monitoring unit configured to monitor a browser invoking behavior in the login procedure or payment procedure;
a keyed content invocation monitoring unit configured to monitor the invocation of keyboard-input content in the login procedure or payment procedure;
a data object monitoring unit configured to monitor data objects transferred by the client in the login procedure or payment procedure; and
a webpage monitoring unit configured to monitor web pages opened in the login procedure or payment procedure.

12. The client according to claim 11, characterized in that, the dangerous process monitoring unit comprises at least one of the following units:
a white list intercepting unit configured to acquire the current process opened in the login procedure or payment procedure, and determine the current process as a dangerous process and intercept it when the current process is not found from the preset white list, wherein the preset white list is used to store secure processes which are already confirmed as not threatening the system; and
a black list intercepting unit configured to acquire the current process opened in the login procedure or payment procedure, and determine the current process as a dangerous process and intercept it when the current process is found from the preset black list, wherein the preset black list is used to store dangerous processes which are already confirmed as threatening the system.

13. The client according to claim 11, characterized in that, the executable file monitoring unit comprises:
a first executable file monitoring unit configured to determine whether the executable file is a suspicious file by looking up from the preset executable file list when detecting that the client gets prepared to receive an executable file or is in a procedure of receiving an executable file or has already received an executable file.

14. The client according to claim 13, characterized in that, the first executable file monitoring unit comprises:
a white list monitoring unit configured to determine the executable file as a suspicious file when the executable file is not found from the preset white list, wherein the preset white list is used to store all secure executable files; or
a black list monitoring unit configured to determine the executable file as a suspicious file when the executable file is found from the preset black list, wherein the preset black list is used to store all dangerous executable files.

15. The client according to claim 11, characterized in that, the executable file monitoring unit comprises:
a second executable file monitoring unit configured to, when the client is detected to have received an executable file, extract behavior characteristics of the executable file, judge whether the behavior characteristics extracted from the executable files are pre-recorded secure behavior characteristics, and determine the executable file as the suspicious file if not.

16. The client according to claim 11, characterized in that, the browser invocation monitoring unit comprises:
a function monitoring unit configured to monitor a function relevant to communication between processes via underlying drive;
an invoking event intercepting unit configured to intercept a corresponding invoking event when relevant function invocation triggered by an operation to the browser process by a remote procedure invoking interface is monitored;
an invoking event parsing unit configured to parse the invoking event, and filter out a process of initiating the invoking event;
an illegal process determining unit configured to determine whether the process of initiating the invoking event is an illegal process by looking up from a preset process list.
